(19) United States
(12) Patent Application Publication
(10) Pub. No.: US 2009/0153612 A1
(43) Pub. Date: Jun. 18, 2009

(54) MULTI-APPLICATION INK JET PRINTING SYSTEM

(76) Inventor: Michael T. Regan, Fairport, NY (US)

Correspondence Address: David A. Novais;Patent Legal Staff, Eastman Kodak Company, 343 State Street, Rochester, NY, 14650-2201, US

(21) Appl. No.: 11/954,280

(22) Filed: Dec. 12, 2007

(51) Int. Cl. B41J 2/015

(52) U.S. Cl. 347/21

(57) ABSTRACT

The invention relates to a method of inkjet printing comprising providing a printhead, providing a controller for the printhead, providing a base ink formulation stream, introducing at least one first enhancer into the base ink stream to form a combined ink stream, adjusting the printhead setpoints and printing the combined ink onto a first substrate.

### FIELD OF THE INVENTION

This invention relates to inkjet printing, and particularly relates to a system for rapidly changing inks to allow printing on different substrates.

### BACKGROUND OF THE INVENTION

Inkjet printing is a non-impact method for producing images by the deposition of ink droplets on a substrate (paper, transparent film, fabric, etc.) in response to digital signals. Inkjet printers have found broad application across markets ranging from industrial labeling to short run printing to desktop document and pictorial imaging and large format printing for outdoor applications such as banners, signages, displays, posters, billboard and bus wraps.

Continuous inkjet printing uses a pressurized ink source that produces a continuous stream of ink droplets. Conventional continuous inkjet printers utilize electrostatic charging devices that are placed close to the point where a filament of ink breaks into individual ink droplets. The ink droplets are electrically charged and then directed to an appropriate location by deflection electrodes. When no printing is desired, the ink droplets are directed into an ink-capturing mechanism (often referred to as a catcher, interceptor or gutter). When printing is desired, the ink droplets are directed to strike a print media.

Typically, continuous inkjet printing devices are faster than drop-on-demand devices and produce higher quality printed images and graphics. However, each color ink printed requires an individual droplet formation, deflection, and capturing system.

Even when black inks are being printed there is generally a need to reconfigure the print head and connect to another ink source when substrates are changed. This is because different inks are preferred for printing on different surfaces. For instance, inks that print well on absorbent paper do not print as well on papers such as coated papers that have a less absorbing surface. Further, there is a demand for inkjet printing on polymer sheets of materials such as polyvinyl chloride and polypropylene. These materials also require different preferred inks in order to adhere to the polymer surface.

Water-based inks have been found to be preferred for environmental reasons, however they present problems with ink adherence to different types of substrates and with some formulations there is a short shelf life of the ink, prior to its no longer being useful for inkjet printing. Ultraviolet curing inks have been found to have excellent adhesion to a variety of surfaces. However they present environmental problems as they may be eye and skin irritants. There is a need water-based inks with the performance of UV inks and at lower cost than the ultraviolet curing inks.

In U.S. Pat. No. 6,908,178 to Jeanmarie, there is disclosed a system for printing different colors onto a substrate. In the system disclosed each inkjet head is capable of being supplied with one of two inks. In U.S. Pat. No. 6,575,566 to Jeanmarie, there is disclosed a continuous inkjet printhead with selectable printing of different volumes of ink.

There remains a need for a continuous inkjet printer that is able to quickly adjust inks to be compatible with a particular substrate fed through the printer without the necessity for stopping the printer or wasting a significant amount of ink as a changeover is carried out.

### SUMMARY OF THE INVENTION

The invention relates to a method of inkjet printing comprising providing a printhead, providing a controller for the printhead, providing a base ink formulation stream, introducing at least one first enhancer into the base ink stream, bringing the combined ink stream into the printhead and printing onto a first substrate.

### BRIEF DESCRIPTION OF THE DRAWINGS

FIG. 1 is a schematic illustration of the method and apparatus of the invention.

### DETAILED DESCRIPTION OF THE INVENTION

The invention has numerous advantages over prior practices in the continuous inkjet art. The invention allows continuous variation of ink composition in a continuous inkjet printer. The ability to vary ink composition allows the effective printing on different substrates without a lengthy changeover to an ink compatible with a different substrate. The system in the invention also provides a low-cost way of shifting inks as opposed to having multiple large tanks of ink that the printer would switch between. The ink flow of the invention is generally uniform even as the compositions vary, thereby minimizing printhead blockage. In view of the ease of switching inks there is no need to use an ink that is not ideally matched for each substrate in order to avoid expensive ink changeovers. The invention allows the ink needs of different substrates to be easily satisfied. Another advantage is that some of the ink enhancers while improving performance of the ink significantly shorten the ink shelf life. In the invention the ink enhancing material is combined with the base ink immediately before printing and shelf life is not an issue. An advantage of the printing system of the invention is that it is possible to respond to workflow by adjusting not only the ink chemistry but also the print head set points to optimize jetting performance of the enhanced ink. Efficiency of the printing system will be enhanced as it is possible to make a fast and automatic response of the printing system to substrate changes. These and other advantages of the invention will be apparent from the specification and drawing.

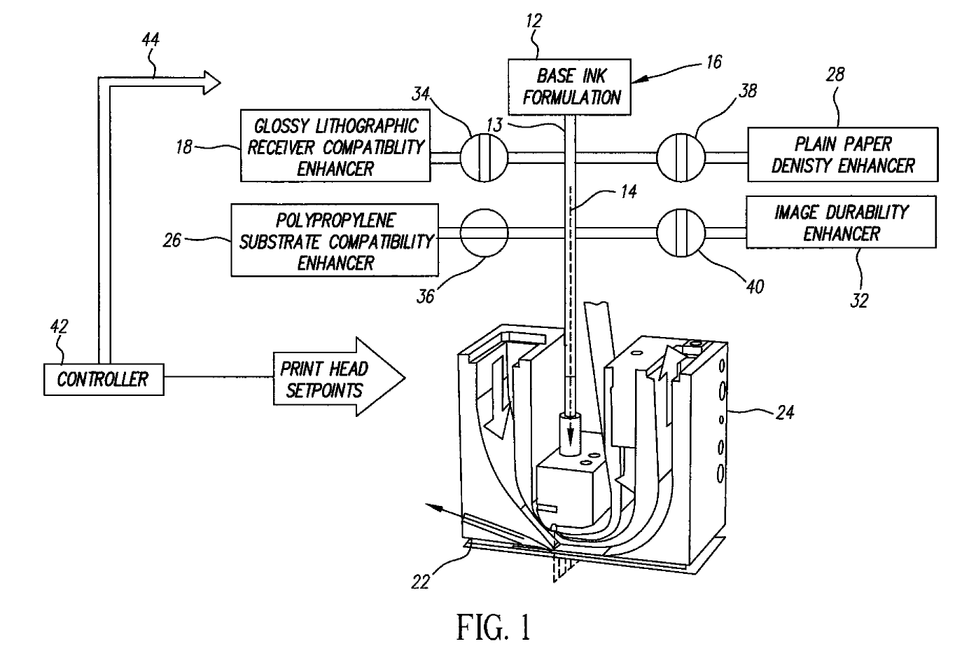

The invention provides a base ink formulation source 12. The base ink formulation 16 is withdrawn from the source 12 by passing the ink stream 14 through tube 13. The base ink formulation 16, if not matched to the substrate 22, will have an enhancer added prior to its reaching the inkjet head 24. Four different enhancers 18, 26, 28, and 32 are shown. The entry of these enhancers into stream 14 is by controlling of valves 34, 36, 38, and 40. FIG. 1 shows the valve 36 open for the polypropylene substrate compatibility ink enhancer 26 to enter the base ink formulation stream 14 in tube 13. These valves are electronically controlled by controller 42 through control means 44. It is possible for the inkjet head 24 to receive ink comprising the base ink formulation and from one to four different enhancer materials for different substrates.

In operation, the inkjet method and apparatus of the invention would in one instance be operated as follows. Substrate 22 would be selected as a substrate having a polypropylene surface, such as used for banners and food wrapping. The base ink formulation 16 would enter tube 13. Polypropylene substrate compatibility enhancer 26 would be added through the valve 36 shown in FIG. 1 in the open position. The blend of the base ink formulation 16 and the polypropylene substrate compatibility enhancer 26 are brought to the inkjet printhead 24. The controller 42 would adjust the printhead set points such that they provide excellent drop formation of the ink that is formed by the combination of the base ink formulation 16 and the polypropylene substrate compatibility enhancer 26. This change in set point would involve the control of the heaters adjacent the ink orifice of the printhead so as to form ink drops at the desired rate and size for printing. The ink with the polypropylene substrate compatibility enhancer 26 would have a different viscosity or weight requiring adjustment of the printhead. The ink would then be applied to the substrate 22 having a polypropylene surface and would adhere to that substrate, whereas the base ink formulation would have poor adhesion.

Similarly, if substrate 22 was a glossy lithographic receiver then the glossy lithographic receiver compatibility enhancer 18 would be metered into stream 14 through valve 34 to combine with the base ink formulation to create an ink satisfactory for a glossy lithographic receiver. The other valves 36, 40 and 38 would be shut off by the controller 44. The same procedure would be followed if a plain paper density enhancer 28 was desired or an image durability enhancer 32 was desired. In each of those instances the stream 14 of the base ink formulation 16 would be enhanced by addition of one of those materials to create an ink particularly desirable for a plain paper density enhancement or to improve durability. It is also possible that both the enhancers 32 and 28 could be added simultaneously to both improve the density and the durability of the base ink formulation 16. In each instance the printhead set points would be adjusted to control the heaters in inkjet head 24 to effectively dispense droplets of the enhanced ink onto the compatible substrate. Further, while the invention has been illustrated with the combined ink stream containing enhancer prepared outside the inkjet head and brought to the head in one stream, it is possible that the base ink and enhancers could be mixed in the inkjet head.

The base ink 16 of the invention in a preferred example would be an aqueous ink formed of a pigment dispersion, a dispersant, a humectant, and a biocide. In humectant would be a glycol based material to aid in drying of the ink. The dispersant could suitably be N-methyl-oleoyl taurate (OMT) or a commercial material surfactant such as Noveon, Solsperse, or surfactants available from Lubizol. The enhancer for glossy lithographic receiver compatibility could suitably be a acrylic latex polymer. The enhancer to improve the adherence to a polypropylene's substrate could suitably be a block copolymer of acrylic acid and ethylene. The enhancer to improve density when printed on plain paper suitably could be a calcium salt of oxalic acid. Enhancer to improve image durability by addition to the base ink formulation suitably could be a polyurethane polymer.

The controllers for ink jet operation are well-known in the art. The control mechanism is shown in U.S. Pat. No. 6,883,904 to Jeanmarie, hereby incorporated by reference in its entirety and particularly with reference to columns 5-8 where the use of the controller to determine drop size and spacing is set forth. The use of a controller to control valves in a liquid configuration from several sources and mixing is well known in the art and its use with the valves of the ink enhancers is typical of such mixing and flow control.

While the invention has been described with four ink enhancer's, the invention could be utilized with a greater number or fewer enhancers. Further, these valves could be provided a valve inlet for flushing fluid to clean the system. Further, other types of enhancers could be utilized. For instance, different colors could be added to a base ink to provide new colors by blending different colors into a base formulation. Further other enhancers, such as ultraviolet inhibitors, could be added for substrates that are intended for exterior use. Enhancers containing fungicides could also be added to form inks for use in the packaging and medical field. These and other variations will be apparent to one of ordinary skill in the art and are intended to be included by the invention as defined in the claims.

### PARTS LIST

| REFERENCE | |
|---|---|
| NUMBER | PART |
| 12 | Source |
| 13 | Tube |
| 14 | Stream |
| 16 | Base |
| 18 | Enhancer |
| 22 | Substrate |
| 24 | Inkjet Head |
| 26 | Enhancer |
| 28 | Enhancer |
| 32 | Enhancer |
| 34 | Valve |
| 36 | Valve |
| 38 | Valve |
| 40 | Valve |
| 42 | Controller |
| 44 | Control |

1. A method of inkjet printing comprising providing a printhead, providing a controller for the printhead, providing a base ink formulation stream, introducing at least one first enhancer into the base ink stream to form a combined enhanced ink stream, adjusting the printhead set points to the enhanced combined ink stream, and printing the combined ink onto a first substrate.

2. The method of claim 1 further comprising ceasing delivery of the first enhancer and substituting at least one second enhancer to form a second combined ink stream, adjusting the printhead set points, and printing the second combined ink onto a second substrate.

3. The method of claim 2 further comprising ceasing delivery of the at least a second enhancer, substituting at least one third enhancer, bringing the combined stream to the printhead, adjusting the printhead set points, and printing onto a third substrate.

4. A method of claim 1 further comprising introducing a second enhancer into the ink stream, adjusting the printhead set points, and printing onto a fourth substrate.

5. The method of claim 1 wherein the at least one first enhancer comprises a colorant.

6. The method of claim 1 wherein the at least one enhancer enhances the ink's performance on a glossy lithographic receiver.

7. The method of claim 1 wherein the at least one enhancer improves the density of the ink on plain paper.

8. The method of claim 1 wherein the at least one enhancer improves the image durability of the image on a substrate.

9. The method of claim 1 wherein the at least one enhancer improves the ink's adherence to polymer substrates.

10. The method of claim 1 wherein said at least one enhancer improves the ink's adherence to polypropylene substrates.

11. The method of claim 1 wherein a second substrate and a second enhancer are substituted for the first substrate and the at least one first enhancer, such that a preferred ink for printing on a second substrate is formed.

12. An apparatus for inkjet printing comprising an inkjet printhead, an inkjet delivery system wherein the inkjet delivery system comprises a base ink supply source, at least one enhancer supply source and a means to bring a stream of base ink from the base ink supply source, and means to bring at least one enhancer into the base ink to form a job specific ink.

13. The apparatus of claim 12 further comprising means to transport a substrate to said printhead for printing.

14. The apparatus of claim 12 wherein said at least one enhancer supply source comprises at least three different enhancer supply sources.

15. An apparatus of claim 12 further comprising a controller to control the blending of the base ink and said at least one enhancer.

16. The apparatus of claim 12 further comprising means to change the printhead set points to match inks created by the addition of at least one enhancer.
